(19) United States
(12) Patent Application Publication
(10) Pub. No.: US 2018/0267218 A1
(43) Pub. Date: Sep. 20, 2018

(54) METHOD FOR MANUFACTURING AN OPTICAL FILTER

(71) Applicant: SCHOTT AG, Mainz (DE)

(72) Inventors: Ulf Georg Brauneck, Gross-Umstadt (DE); Dirk Apitz, Lausanne (CH)

(73) Assignee: SCHOTT AG, Mainz (DE)

(21) Appl. No.: 15/922,975

(22) Filed: Mar. 16, 2018

(30) Foreign Application Priority Data
Mar. 16, 2017 (DE) 102017105642.4

(51) Int. Cl. G02B 5/22

(52) U.S. Cl. CPC G02B 5/22

(57) ABSTRACT

Optical filters and methods of producing are provided. The method includes: providing a plurality of optical elements each with a substrate having two opposing major surfaces; providing a spacer or a surface-covering adhesive layer for holding the optical elements at a predefined distance; assembling the optical elements such that the optical elements are arranged adjacent to each other to define the optical filter, the optical elements having adjacent elements that are held at a predefined distance and with a cavity in between by the spacer or surface covering adhesive layer; determining an examination property regarding optical properties; and using the examination property for the step of assembling the optical elements and/or for performing a refinement step on the optical elements.

### CROSS REFERENCE TO RELATED APPLICATIONS

This application claims benefit under 35 U.S.C. 119(a) of German Application No. 102017105642.4, filed Mar. 16, 2017, the entire contents of which are incorporated herein by reference.

### BACKGROUND

### 1. Field of the Invention

The invention relates to the field of manufacturing optical filters, in particular as a customized product whose optical properties satisfy customer specified quality standards. The invention further relates to optical filters in general.

### 2. Description of Related Art

Optical filters are used to select radiation according to certain criteria. Optical short-pass, long-pass or band-pass filters, for example, are characterized by at least two or three spectral ranges having typically very different light transmittance with respect to each other. Spectral ranges with very low light transmittance may be referred to as a light-blocking ranges and prevent light from passing the filter, while spectral ranges with higher light transmittance select the wavelengths of the incident light passing the filter. Between a light-blocking spectral range and a light-transmitting spectral range, the transmittance curve is often desired to adopt a steep slope, i.e. to form high edge steepness.

Furthermore, spectral properties of an optical filter are often desired to remain as constant as possible over the aperture area, i.e., remain constant for every area element of the aperture area. Achieving such high optical homogeneity becomes particularly challenging as the aperture area increases.

Another characteristic value relating to the quality of an optical filter is the transmitted wavefront distortion, which describes the variations imposed on the wavefronts when passing the optical filter. The transmitted wavefront distortion is linked to the accuracy of the surfaces of the optical elements employed in an optical filter. Therefore, achieving low wavefront distortions also becomes increasingly difficult for large aperture areas.

As a consequence, large aperture homogeneous filters with low wavefront distortion and high edge steepness are notoriously difficult to manufacture. Additionally, in conventional mass production of optical filters, the tolerances of optical properties are often not optimized on an individual (per-filter) basis.

### SUMMARY

An object of the invention is to enable the manufacture of optical filters having minimal tolerances of optical properties, in particular to provide optical filters with individually optimized optical properties for every single optical filter itself.

An aspect of the invention is to provide concepts for manufacturing optical filters with large aperture area, low transmitted wavefront distortions, high spectral uniformity and/or high edge steepness, in particular at the same time and according to customer specified quality standards.

The invention provides a method for manufacturing an optical filter, in particular as a customized product whose optical properties satisfy customer specified quality standards.

The method is suited for manufacturing an optical filter, which is either a short-pass filter, a long-pass filter or a band-pass filter having at least one light-transmitting spectral range and at least one light-blocking spectral range, wherein the average transmittance of the optical filter within the light-transmitting spectral range exceeds 50 percent, preferably 70 percent and more preferably 80 percent, and the average transmittance within the light-blocking spectral range is less than 5 percent.

The light-transmitting spectral range may for example have a width of more than 0.1 nanometers, preferably of more than 200 nanometers and less than 12000 nanometers, preferably less than 10000 nanometers.

The method for manufacturing an optical filter comprises providing at least two (i.e. a plurality) of optical elements, whereat each optical element comprises a substrate with two opposing major surfaces. The size of the optical elements preferably is equal to (or slightly larger) than the aperture area of the optical filter.

The method also comprises providing at least one spacer for holding at least two of the optical elements at a predefined distance, preferably with a tolerance of less than 1000 micrometers. The distances may in particular be higher than usual distances in free-space optics. Instead of using a spacer and an air gap, a surface-covering adhesive layer may also be used. During curing the adhesive layer, additional spacers may be used for stabilizing that can be removed after curing.

Since in such a case also the evenness of the components may play a role and not only the thickness variation, a local polishing process can be advantageous after the adhesive process in order to meet the tolerances.

The method further comprises assembling the plurality of optical elements such that they are arranged adjacent to each other and that at least two adjacent optical elements are firmly held at a predefined distance and with a cavity in between by the at least one spacer. Furthermore, the assembly is preferably performed such that the surface normals at the center of each major surface of each optical element is with a deviation of less than 5 degrees, preferably of less than 5 arc minutes, parallel to the optical axis of the optical filter.

In the context of the invention, the method further comprises determining at least one examination property regarding the optical properties of the optical filter, e.g. by an experimental measurement on the filter or on its components. The examination property is used for assembling the plurality of optical elements in an optimized manner and/or for performing at least one refinement step on at least one of the optical elements.

An advantage, in particular in view of conventional mass production, comprises that each filter is adjusted individually depending on e.g. experimentally measured values. In other words, not every filter is assembled in the exact same manner; rather, for each filter to be manufactured, individual optimizations can be made. Such a customized procedure allows for compensation and/or reduction of tolerances and/or deviations, which may occur during the production or processing of the components of the filter.

The method is in particular advantageous for manufacturing an optical filter with an aperture area of at least 1225 square millimeters, in particular a diameter of at least 50 millimeters (e.g. if the aperture area is circular) or a diagonal of at least 50 millimeters (e.g. if the aperture area is a square).

In an embodiment of the invention, the method further comprises coating at least one major surface of a substrate of at least one of the optical elements with a layer of coating material.

Coating may in particular be performed using sputter deposition. Then, a deposition mask may optionally be used during sputter deposition for influencing the spatial distribution and/or thickness of the layer of coating material.

Also, when using sputter deposition, a magnetic field may be optionally used during sputter deposition for influencing the spatial distribution and/or thickness of the layer of coating material.

In other words, magnetron sputter deposition (magnetron sputtering) may in particular be used. Another preferred option is to use ion beam sputter deposition (ion beam sputtering).

Standing below, some experimentally determinable examination properties, which may be used for individually adjusting the optical filter, are described.

Accordingly, in an embodiment of the invention, the method comprises determining a transmitted wavefront distortion (TWD) as an examination property. The transmitted wavefront distortion is determined for radiation of at least one test wavelength, preferably of 632.8 nanometer, passing through an optical system which is either the optical filter as a whole or at least one of its optical elements. In other words, the TWD, as an examination property, is determined either of the fully assembled optical filter itself or of a subsystem comprising at least one optical element of the optical filter.

Preferably, the transmitted wavefront distortion is defined as the standard deviation of a difference variable (as further specified below) for at least 1000 points being regularly or statistically distributed over a calculation area (as further specified below) of transmitted wavefronts of a plane wave of the test wavelength being transmitted through the optical system in direction of the optical axis of the optical system.

The mentioned difference variable specifies the distance in direction of the optical axis between the transmitted wavefronts and a plane which is perpendicular to the optical axis and located at the mean value of the at least 1000 points.

The mentioned calculation area of transmitted wavefronts is the projection of a planar area (preferably of a circular area with a diameter of 25.4 millimeter) which is perpendicular to the optical axis, along the optical axis onto the wavefronts. Alternatively, the calculation area may also correspond to the aperture area.

It may be particularly preferred, that the transmitted wavefront distortion is determined for a series of calculation areas, e.g. circular areas with a diameter of 25.4 millimeter, such that the entire aperture area (or some other in particular customer specified area such as e.g. an area of 100×100 or 80×30 millimeter or of a diameter of 100 or 160 millimeter) is covered by the series of calculation areas.

Preferably, this embodiment of the invention comprises comparing the determined transmitted wavefront distortion with a specified quality standard. The specified quality standard may in particular comprise said determined transmitted wavefront distortion to be less than half, preferably less than a quarter, more preferably less than an eighth, and most preferably less than a twelfth of said at least one test wavelength. It may be particularly preferred, if this condition is fulfilled for every calculation area of a series of calculation areas, if such a series is used as described above.

In another embodiment of the invention, the method comprises determining the variation of a characteristic wavelength as an examination property, wherein this variation of a characteristic wavelength is determined over the aperture area of an optical system which is either the optical filter as a whole or at least one of its optical elements. In other words, the variation of a characteristic wavelength, as an examination property, is determined either of the fully assembled optical filter itself or of a subsystem comprising at least one optical element of the optical filter.

Preferably, the characteristic wavelength is defined as a wavelength between a light-transmitting spectral range and a light-blocking spectral range at which the transmittance of the optical system is |T̅_̅{̅L̅T̅}̅+T̅_̅{̅L̅B̅}̅|/2, wherein T̅_̅{̅L̅T̅}̅ is the average transmittance within the light-transmitting spectral range and T̅_̅{̅L̅B̅}̅ is the average transmittance within the light-blocking spectral range. In this case, the characteristic wavelength is a transition wavelength, or in other words an edge location. The characteristic wavelength may also be a central wavelength of a specific spectral range, e.g. the central wavelength of the light-transmitting spectral range of a band pass filter comprising a light-transmitting spectral range in between two light-blocking spectral ranges. In this case, the characteristic wavelength may in particular be defined as the average of the respective two transition wavelengths.

Preferably, this embodiment of the invention comprises comparing the determined variation of a characteristic wavelength with a specified quality standard, which in particular comprises the determined variation of a characteristic wavelength to be less than ±0.25 percent, preferably less than ±0.15 percent.

In other words, this quality standard requires that the standard deviation of the characteristic wavelength with respect to different area elements of the aperture area is below ±0.25 percent, preferably less than ±0.15 percent.

In yet another embodiment of the invention, the method comprises determining an edge steepness as said examination property. This edge steepness is determined of an optical system which is either the optical filter as a whole or at least one of its optical elements.

Preferably, this edge steepness is defined as |λ_{LT}−λ_{LB}|/λ_{LB}, wherein λ_{LT} is the boundary wavelength of a light-transmitting spectral range facing a light-blocking spectral range and λ_{LB} is the boundary wavelength of the light-blocking spectral range facing the light-transmitting spectral range.

For example, in a short-pass filter, λ_{LT} may be the upper boundary wavelength of the light-transmitting spectral range and λ_{LB} may be the lower boundary wavelength of the light-blocking spectral range. In a long-pass filter, in contrast, λ_{LT} may be the lower boundary wavelength of the light-transmitting spectral range and λ_{LB} may be the upper boundary wavelength of the light-blocking spectral range.

Preferably, this embodiment of the invention comprises comparing the determined edge steepness with a specified quality standard, which in particular comprises said determined edge steepness to be less than 2 percent, preferably less than 0.7 percent.

In yet another embodiment of the invention, the method comprises determining a transmittance and/or reflectance spectrum as an examination property, wherein this transmittance and/or reflectance spectrum is determined of an optical system being either the optical filter as a whole or at least one of the optical elements.

Preferably, this embodiment of the invention comprises comparing the determined transmittance and/or reflectance spectrum with a specified quality standard.

In yet another embodiment of the invention, the method comprises determining a spatial variation of a layer thickness as an examination property, wherein this variation of a layer thickness is determined of a layer of coating material deposited on a major surface of a substrate of at least one of the optical elements.

Preferably, this embodiment of the invention comprises comparing this determined spatial variation of a layer thickness with a specified quality standard.

In a preferred embodiment of the invention, the method comprises determining a first examination property of a first optical element, preferably before assembling the plurality of optical elements as well as determining a second examination property of a second optical element, again preferably before assembling said plurality of optical elements.

Based on the determined first examination property and the determined second examination property, a relative examination property is calculated and preferably compared with a specified quality standard.

The relative examination property is used for assembling the first and second optical element with an optimized geometric relationship between each other. In particular, their relative rotational angle with respect to the optical axis and/or their relative facing orientation and/or their relative distance along the optical axis may be adjusted depending on the relative examination property.

In another preferred embodiment of the invention, the method comprises determining an examination property of either the optical filter as a whole or of at least one of its optical elements, preferably after assembling at least partially the plurality of optical elements.

The determined examination property is then compared with a specified quality standard for this examination property in order to decide, whether the determined examination property satisfies said specified quality standard.

If the decision is negative, i.e. the quality standard is not met, i.e. not fulfilled, at least one refinement step (such as mentioned below) is performed on at least one of the optical elements. Furthermore, after refinement, it is preferred to repeat the steps of determining the examination property, in particular the same property, and comparing it to the quality standard until the decision is positive.

In case that the examination property is determined of the optical filter as a whole or of already at least partially assembled components, a disassembly may precede the refinement step on an optical element.

This process advantageously allows for an iterative improvement of the optical properties of the optical filter.

In an embodiment of the invention, the method comprises performing a refinement step on at least one of the optical elements. The refinement step on the optical element may at first comprise disassembling the optical element. The refinement step may further comprise polishing the optical element.

If sputter deposition used, the refinement step may comprise adjusting the deposition mask, in particular the shape of the deposition mask and/or adjusting the magnetic field, in particular the spatial distribution of the magnetic field. The refinement step may further comprise re-coating at least one of the major surfaces of the substrate the optical element using sputter deposition. Re-coating may in particular be performed on top of the previous coating and may compensate for spatial variations of the thickness of the coating.

Regarding the assembly of the optical element, the refinement step may further comprise adjusting the facing orientation of said at least one optical element with respect to an adjacent optical element, i.e. flipping the orientation of the optical element and/or adjusting the rotational angle of the optical element around the optical axis and/or adjusting the position of the optical element on the optical axis.

An advantage of the invention in particular is that several optical properties can be optimized at the same time. Thus, optical filters can be manufactured, which are characterized at the same time by optimized and verified low transmitted wavefront distortion, high spectral uniformity, high edge steepness, and a large aperture area. Moreover, the low transmitted wavefront distortion may be optimized and verified for more than just one test wavelength, in particular for a whole spectral range of e.g. 360 nanometers to 1100 nanometers.

The invention also relates to an optical filter, which is either a short-pass filter, a long-pass filter or a band-pass filter with at least one light-transmitting spectral range and at least one light-blocking spectral range.

The optical filter comprises at least one optical element comprising a substrate with two opposing major surfaces.

Furthermore, the optical filter is characterized by one or more of the following features: (i) the optical filter has an aperture area of at least 1225 square millimeters; (ii) the transmitted wavefront distortion (TWD) of the optical filter for at least one test wavelength, preferably of 632.8 nanometer, is less than half, preferably less than a quarter, more preferably less than an eighth of the test wavelength; (iii) the variation of a characteristic wavelength over the aperture area of the optical filter is less than ±0.25 percent, preferably less than ±0.15 percent.

In an embodiment of the optical filter, the transmittance of the optical filter transitions between a light-transmitting spectral range and a light-blocking spectral range with an edge steepness of less than 2 percent, preferably of less than 0.7 percent.

In a further embodiment of the optical filter, the filter comprises two or more optical elements (i.e., a plurality of optical elements) and at least one spacer, wherein the optical elements are arranged adjacent to each other and such that at least two adjacent optical elements are firmly held at a predefined distance and with a cavity in between by the spacer. Preferably, the surface normal at the center of the major surfaces of the optical elements is with a deviation of less than 5 degrees, preferably less than 5 arc minutes, parallel to the optical axis of the optical filter.

In a further embodiment of the optical filter, at least one of said major surfaces is coated with at least one optical layer.

In a further embodiment of the optical filter, the substrate of at least one optical element is an optical glass (e.g. BK7, SCHOTT N-BK7, B270, D263 E, quartz glass), a technical glass (e.g. Borofloat®, Xensation® Cover, AF 32), a filter glass (e.g. RG715, BG55), an infrared material (e.g. ZnS, ZnSe, Ga, Si, chalcogenide glass), or a crystal (e.g. sapphire or calcium fluoride). The substrate may also be a sandwich comprising two or more materials.

In a further embodiment of the optical filter, at least one of the major surfaces of a substrate of at least one optical element is of flat, convex or concave shape.

### BRIEF DESCRIPTION OF THE DRAWINGS

The patent or application file contains at least one photograph executed in color. Copies of this patent or patent application publication with color photograph(s) will be provided by the Office upon request and payment of the necessary fee.

The invention is explained below in more detail and reference is made to the drawings, wherein:

FIGS. 1a and 1b show schematic representations of optical elements with coating layers,

FIGS. 2a and 2b show schematic representations of optical filters comprising pluralities of optical elements,

FIGS. 3a and 3b show sectional drawings through optical filters comprising optical elements and spacers,

FIG. 4 shows spectral transmittance curves for five different positions on the aperture of an optical band pass filter according to the invention,

FIG. 5 shows spectral transmittance curves for five different positions on the aperture of another optical band pass filter according to the invention,

FIG. 6 shows a density plot of a measurement within an area of 25×25 millimeter of a wavefront transmitted through an optical filter according to the invention, the measurement being suitable for determining a transmitted wavefront distortion,

FIG. 7 shows a density plot of a measurement within an area of 101×96 millimeter of another wavefront transmitted through an optical filter according to the invention, the measurement, being suitable for determining a transmitted wavefront distortion,

FIG. 8 shows a density plot of a measurement within an area of 25×25 millimeter of yet another wavefront transmitted through an optical filter according to the invention, the measurement, being suitable for determining a transmitted wavefront distortion, and

FIG. 9 shows a density plot of a measurement within an area of 101×96 millimeter of yet another wavefront transmitted through an optical filter according to the invention, the measurement, being suitable for determining a transmitted wavefront distortion.

### DETAILED DESCRIPTION

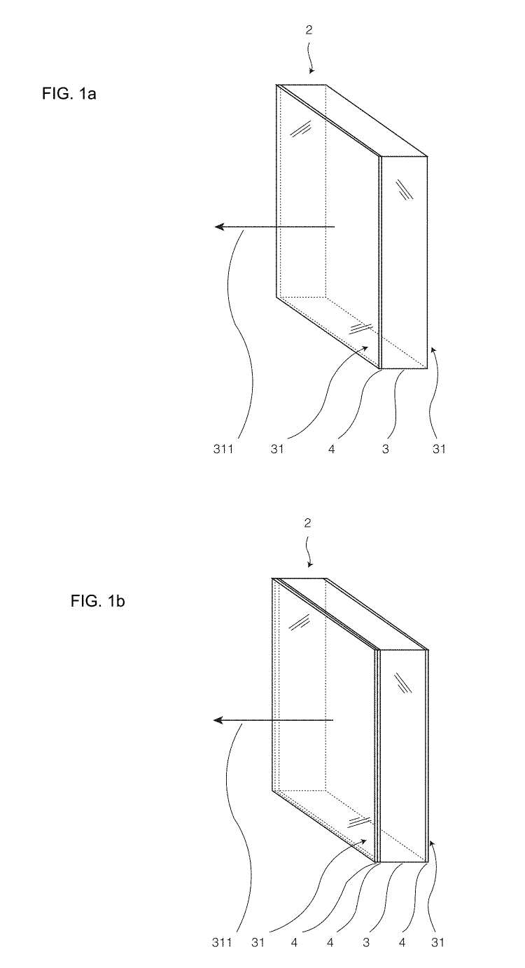

Referring to FIGS. 1a and 1b, the optical element 2 comprises a substrate 3 with two major surfaces 31. In this example, the optical element 2 is of rectangular shape and the major surfaces 31 are flat. The surface normal 311, which is perpendicular to the major surface 31, defines an optical axis of the optical element 2.

Referring to FIG. 1a, one of the major surfaces 31 of the optical element 2 is coated with an optical layer 4. This thin film layer has a different refractive index than the refractive index of the substrate 2 and the refractive index of the atmosphere or air surrounding the optical element 2. The optical layer 4 may for example be an anti-reflective coating, which reduces the air-glass reflectance. The thickness of the optical layer 4 may for example be a quarter of a wavelength within the light-transmitting spectral range of the optical filter 2.

Referring to FIG. 1b, one of the major surfaces 31 is coated with a double layer, that is, with two optical layers 4. The two optical layers 4 may comprise different materials and may have different refractive indices. Such a double layer coating may for example be used to reduce the reflectance as compared to a single layer coating.

The other major surface 31 of the optical element 2 is coated with an optical layer 4 as well. As is known to the person skilled in the art, the illustrated coatings are to be understood only as examples. It may in particular also be desired to apply a substantially higher number of layers on one or both major surfaces 31 of an optical element 2.

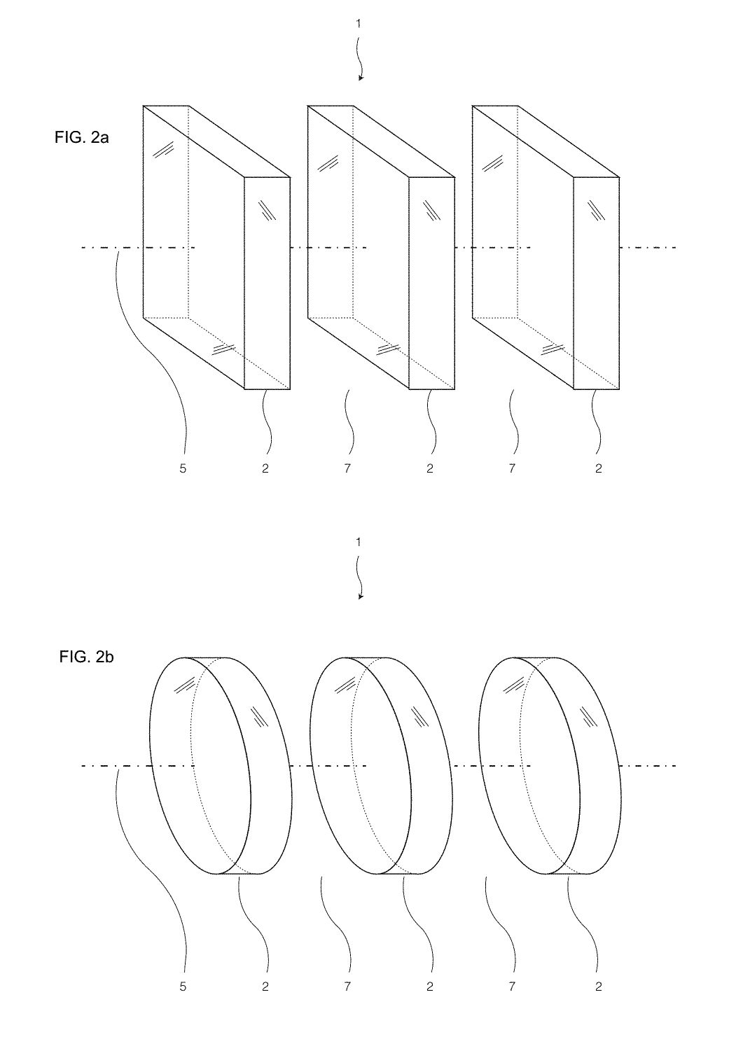

Referring to FIGS. 2a and 2b optical filters 1 comprise multiple optical elements 2 arranged adjacent to each other, whereat in FIG. 2a, the optical elements are of rectangular shape (e.g. with a diagonal of at least 75, preferably of at least 100, more preferably of at least 150 millimeters) and in FIG. 2b, the optical elements are of disc shape (e.g. with a diameter of at least 75, preferably of at least 100, more preferably of at least 150 millimeters).

The optical elements 2 are arranged adjacent to each other in such a way that cavities 7, i.e., gaps, are defined in between each pair of adjacent optical elements 2. The surface normals 31 of the optical elements 2 are essentially parallel to each other (at least within a tight tolerance of e.g. less than 30 arc minutes) and define the optical axis 5 of the optical filter 1.

When a light wave passes through the optical filter 1, wavefronts of the light wave may for example (in an ideal case) be perpendicular to the optical axis 5 and propagate along the direction of the optical axis 5.

The optical filter 1 may be short-pass or a long-pass filter having a light-transmitting spectral range adjacent to a light-blocking spectral range, whereat the light-transmitting spectral range may e.g. have an average transmittance T̅_̅{̅L̅T̅}̅ of more than 80 percent, while the light-blocking spectral range may e.g. have an average transmittance T̅_̅{̅L̅B̅}̅ of below 5 percent. Hence, the transmittance of the optical filter 1 transitions from a high transmittance from within the light-transmitting spectral range to a low transmittance within the light-blocking spectral range. The wavelength at which the transmittance adopts the average value |T̅_̅{̅L̅T̅}̅+T̅_̅{̅L̅B̅}̅|/2 may be denoted as transition wavelength, which also defines the edge position of a short-pass or a long-pass filter. The edge position may for example be at a value within the interval from 190 to 3000 nanometers.

The optical filter 1 may also be a band-pass filter having a light-transmitting spectral range which is adjacent to two light-blocking spectral ranges located on both sides of the light-transmitting spectral range. A band-pass filter may be characterized by a central wavelength in the center of the light-transmitting spectral range. The central wavelength may for example take a value within the interval from 200 to 3000 nanometers.

An aspect of the quality of the optical filter 1 is the variation of a characteristic wavelength such as a central wavelength or a transition wavelength over the full free aperture. Within the context of the invention, such a variation may be reduced using a variety of refinement steps on the optical elements 2 and/or their arrangement. A preferred quality standard may be that the variation of such a characteristic wavelength (e.g. central wavelength in the case of a band pass, or transition wavelength in the case of a short-pass or long-pass) is equal to or lower than +−0.25% of the characteristic wavelength over the full free aperture (for peak-to-valley). Another preferred quality standard may be that the variation of such a characteristic wavelength is equal to or lower than +−0.1% of the characteristic wavelength for each diameter of 25.4 millimeters (for peak-to-valley).

In practice, the major surfaces 31 of the optical elements 2 typically comprise smallest irregularities, which may also be a result of applying one or more coating layers onto a surface. These irregularities can lead to a distortion of the wavefronts, e.g. of a light wave of 633 nanometers, passing through the optical filter 1, i.e. to a so-called transmitted wavefront distortion (TWD). Within the context of the invention, the TWD may be determined (e.g. using a Shack-Hartmann sensor) and may also be reduced using a variety of refinement steps on the optical elements 2 and/or their arrangement.

Thus, the optical filter 1 is advantageously characterized by a very low transmitted wavefront distortion, which in particular may be less than half the test wavelength at 632.8 nanometres over a diameter of 100 millimeters (for peak-to-valley) or more particular may be less than a quarter of the test wavelength at 633 nanometres over an area of 80χ30 millimeter. It may also be preferred that the optical filter 1 has a TWD which is less than an eighth of the test wavelength for each diameter of 25 millimeters.

In an embodiment of the invention, the TWD of the optical filter 1 and/or one or more optical elements 2 is checked for a test spectral range, such as a range extending from 360 nanometers to 1100 nanometers, preferably from 300 to 2000 nanometers, more preferably from 190 to 3000 nanometers. To this end, determining the TWD as an examination property (and refinement steps) can be performed for a plurality of test wavelengths, e.g. 10 test wavelengths, being spread over the test spectral range.

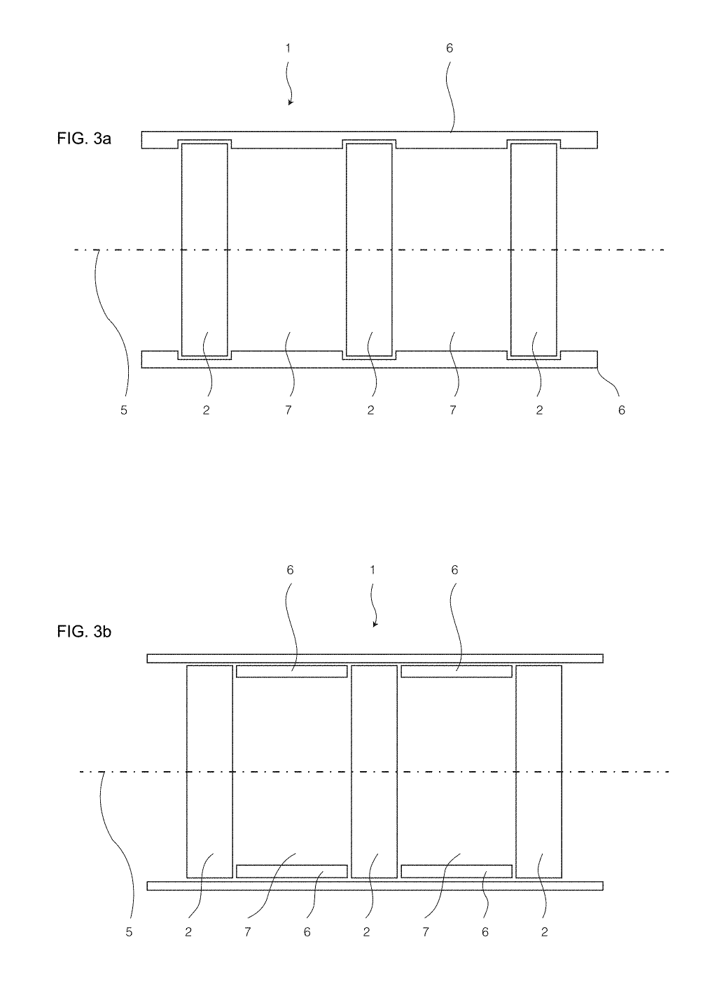

Referring to FIGS. 3a and 3b, the optical elements 2 are held adjacent to each other at predefined distances by means of spacers 6. The spacers 6 may for example be designed as a tube for the optical filter 1, as shown in FIG. 3a, or as spacer elements for pairs of adjacent optical elements 2, as seen in FIG. 3b. The spacer 6 may be designed in such a way that the optical element 2 may successively be attached or inserted to the spacers 6 in order to assemble the optical filter 1. It may be provided in particular that the optical filter 1 is disassemblable again. This has the advantage, that examination properties of the optical filter or its components can be determined in an at least partially assembled state of the optical filter 1, while refinement steps e.g. on the optical elements 2 can be performed after disassembling the respective components.

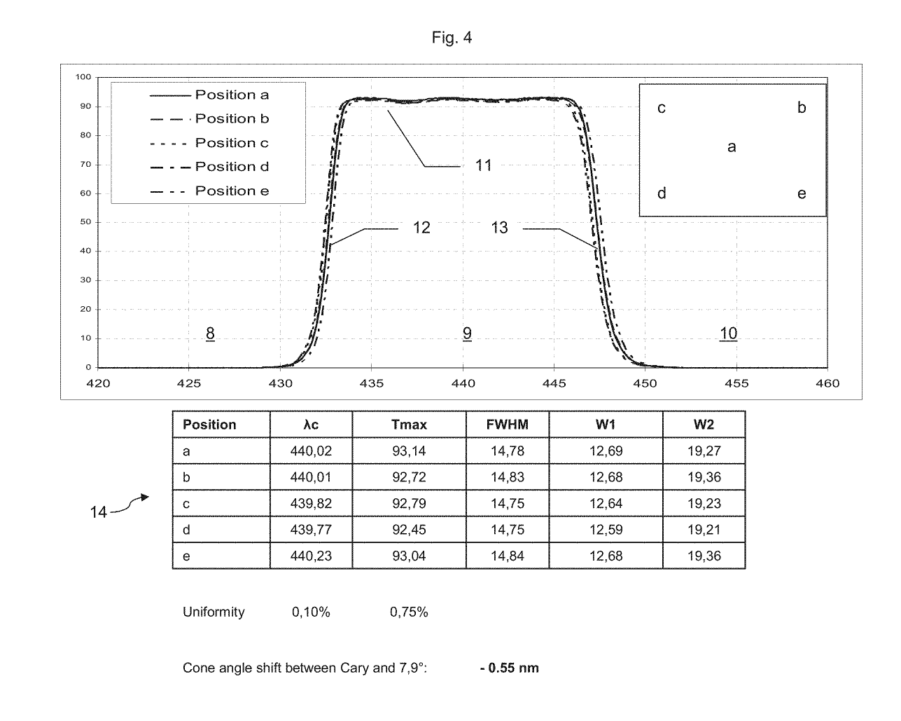

FIG. 4 shows five spectral transmittance curves 11 for positions a, b, c, d, e on the aperture of an optical band pass filter according to the invention.

For each position a, b, c, d, e, the band pass filter comprises a first light-blocking spectral range 8, a light-transmitting spectral range 9 and a second light-blocking spectral range 10, whereat the transmittance continuously transitions from a value of below 0.0003% within the light-blocking range 8 to a value of more than 92% (Tₘₐₓ) within the light-transmitting range 9 and again to a value of below 0.0003% within the light-blocking range 10.

Referring to table 14, the central wavelength λ_{c} (as a characteristic wavelength) may be determined as the mean value of the first transition wavelength (between the light-blocking range 8 and the light-transmitting range 9) and the second transition wavelength (between the light-transmitting range 9 and the light-blocking range 10). Each of these transition wavelengths may be given by the wavelength at Tₘₐₓ/2. Here, for the positions a, b, c, d, e on the aperture area, the central wavelength λ_{c} exhibits a variation of 0.1 percent over the aperture area.

The full width at half maximum (FWHM) is the difference between the first transition wavelength and the second transition wavelength, i.e., the width of the light-transmitting spectral range 9 at half maximum transmittance. The widths W1 and W2 are the width of the light-transmitting spectral range at maximum and minimum transmittance, respectively.

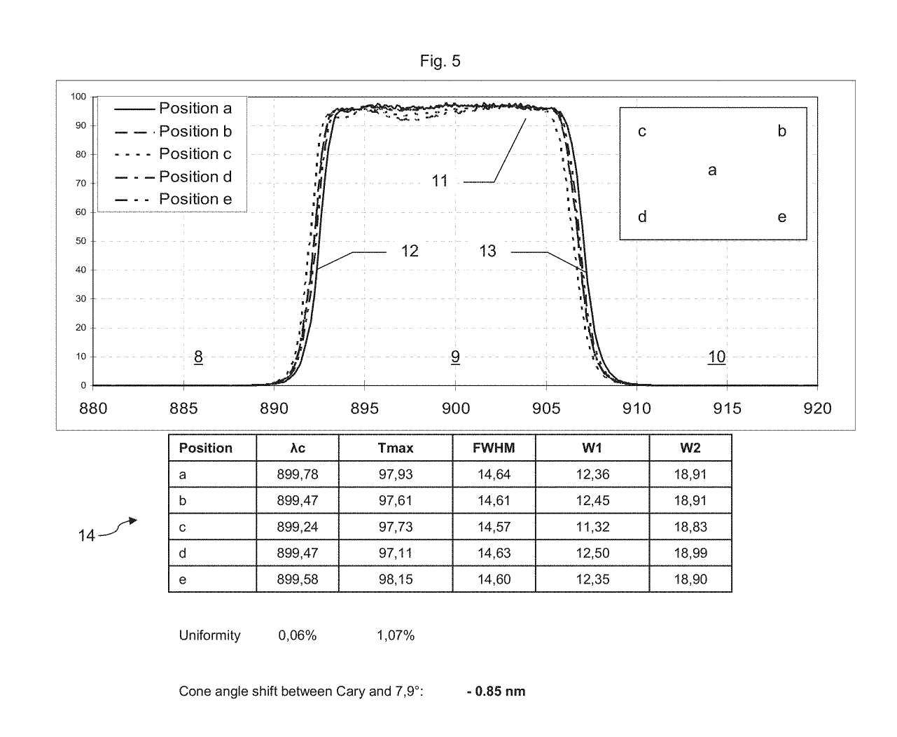

FIG. 5 shows five spectral transmittance curves 11 for positions a, b, c, d, e on the aperture of another optical band pass filter according to the invention.

For this band pass filter, for the positions a, b, c, d, e, the central wavelength λ_{c} exhibits a variation of 0.06 percent over the aperture area.

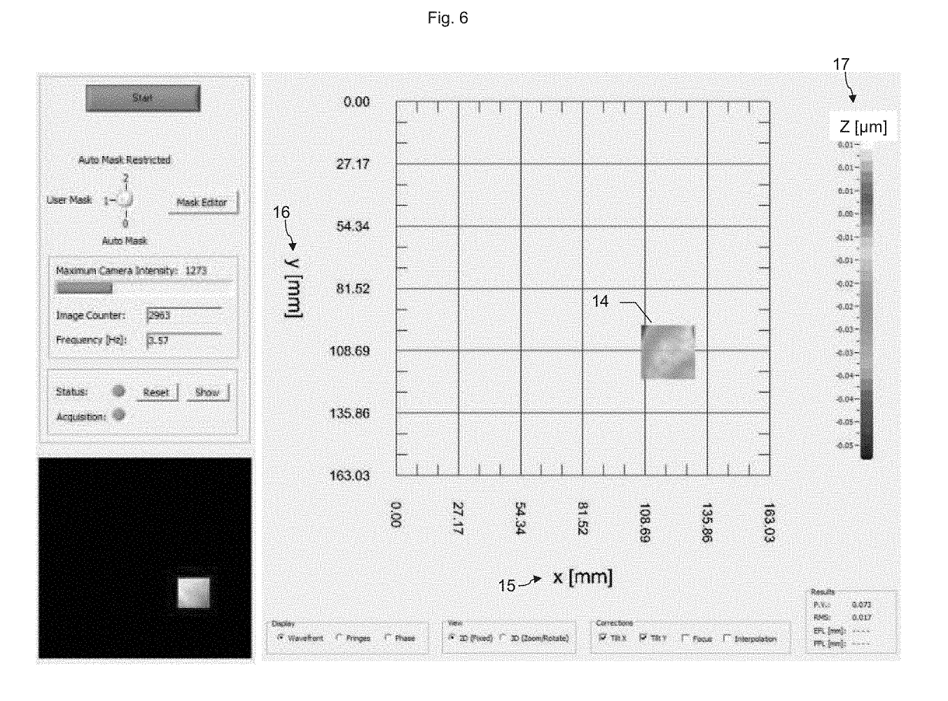

FIG. 6 shows a density plot of a measurement within an area of 25×25 millimeter (x-axis 15 and y-axis 16) of a distorted wavefront 14 transmitted through an optical band pass filter according to the invention. The z-axis 17 corresponds to the optical axis of the filter.

The measurement was done through the entire area of the component of 163×163 millimeter. The displayed area of 25×25 millimeter is a part of the entire area of 163×163 millimeter and is selected among all areas 25×25 millimeter within the area of 163×163 millimeter such as to correspond to the largest transmitted wavefront distortion. In other words, for all other areas of 25×25 millimeters within the area of 163×163 millimeters, the transmitted wavefront distortion (TWD) is smaller than the value of the TWD for the displayed area of 25×25 millimeters.

Since the incident light on the optical filter, which in this case has a wavelength of λ=440 nanometres, is characterized by highly planar wavefronts, the measured transmitted wavefront 14 indicates the wavefront distortion (wavefront error) being introduced by the optical filter.

The transmitted wavefront distortion (TWD) may be evaluated as the standard deviation of the z-values, in this case yielding RMS=0.017 micrometers. The TWD may be desired to be below λ/10, preferably below λ/12 or more preferably below λ/15 for each area of 25×25 millimeters on the aperture of the optical filter. This quality standard is satisfied in this case (λ/20=0.03 micrometers, whereas the reference wavelength is 633 nanometers according to MIL standard). Note that the reference wavelength (often the wavelength of a He—Ne laser used in an interferometer) is not necessarily also the measurement wavelength. For narrow bandpass filters, for example, a universal wavelength of 633 nanometers may be unsuitable. In the displayed case the transmitted wavefront distortion has been measured using a white light Shack-Hartman sensor.

Alternatively, the TWD may also be characterized by the difference between peak and valley of the z-values, in this case P.V.=0.073 micrometers. The P.V. may be desired to be below 0.1 micrometers, preferably below 0.75 micrometers for each area of 25×25 millimeters on the aperture of the optical filter.

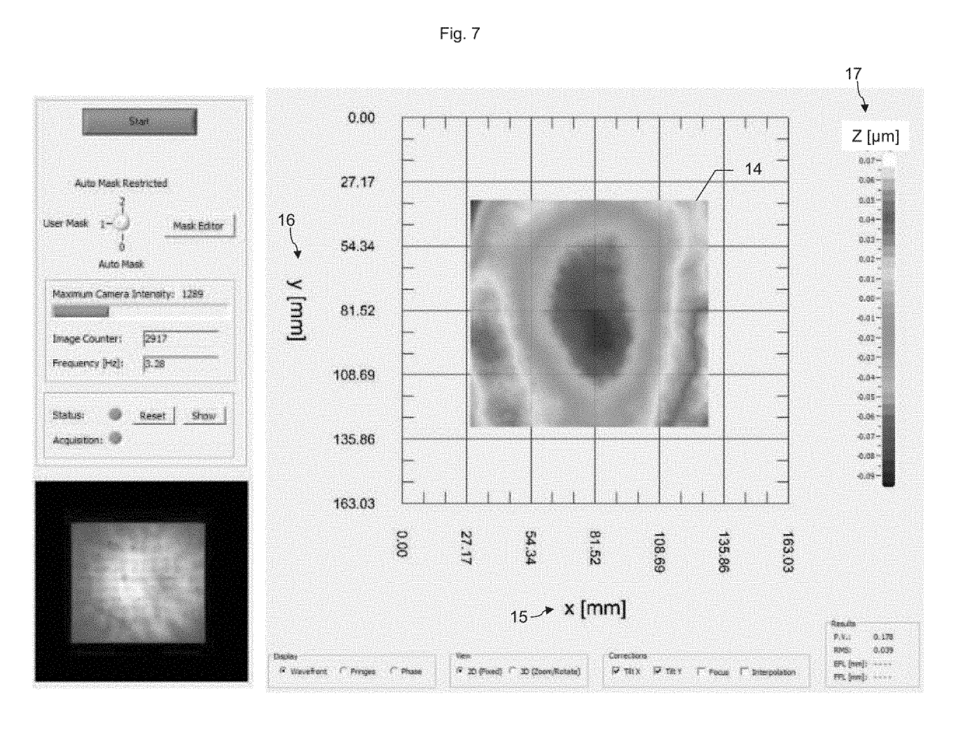

FIG. 7 shows a density plot of a measurement within an area of 101×96 millimeters of another distorted wavefront 14 transmitted through an optical band pass filter according to the invention. The measurement (which belongs to the same experiment as in FIG. 6) was performed based on the entire area of the same component of 163×163 millimeters. In this case, however, the analysis area corresponding to the largest TWD is larger. In this case, the measured area, which is more than 9000 square millimeters, corresponds to the aperture of the optical filter. The TWD (RMS=0.039 micrometers) is below V10 and even below λ/15 (λ/15=0.04 micrometers with λ=633 nanometers being the reference wavelength). The P.V. difference (0.178 micrometers) is below 0.2 micrometers for the aperture area of the optical filter.

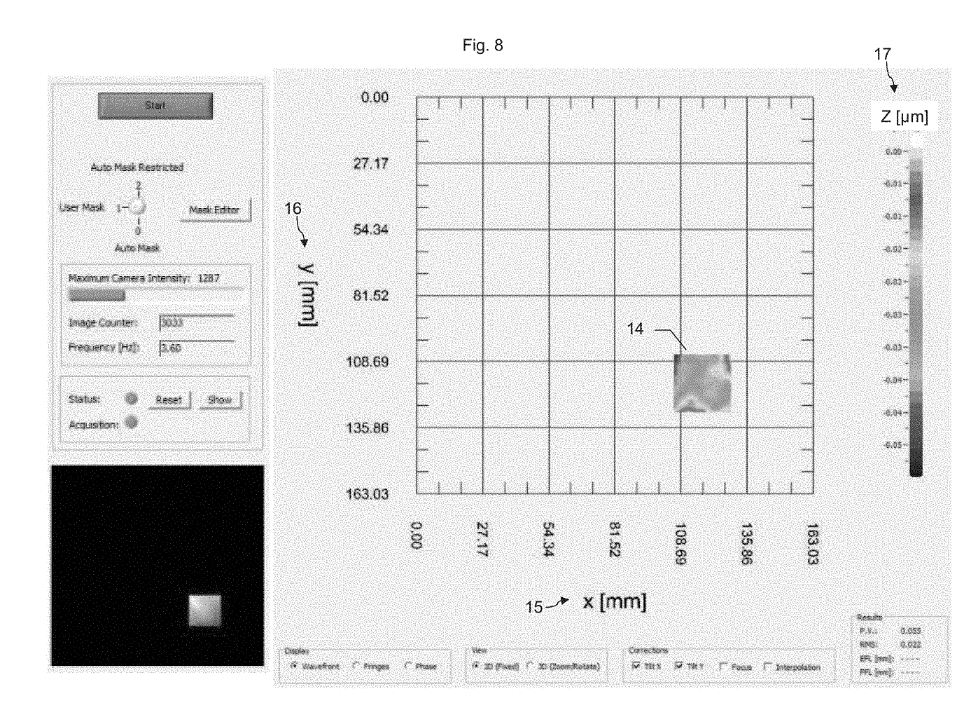

FIG. 8 shows a density plot of a measurement within an area of 25×25 millimeters of yet another distorted wavefront 14 transmitted through an optical band pass filter according to the invention. The measurement was again performed for the entire area of the analysed component and the displayed area selected such as to maximize the TWD. The TWD (RMS=0.022 micrometers) is below λ/10, below λ/15 and even below λ/20 (V20=0.03 micrometers for)=633 nanometers). The P.V. difference (0.055 micrometers) is even below 0.06 micrometers.

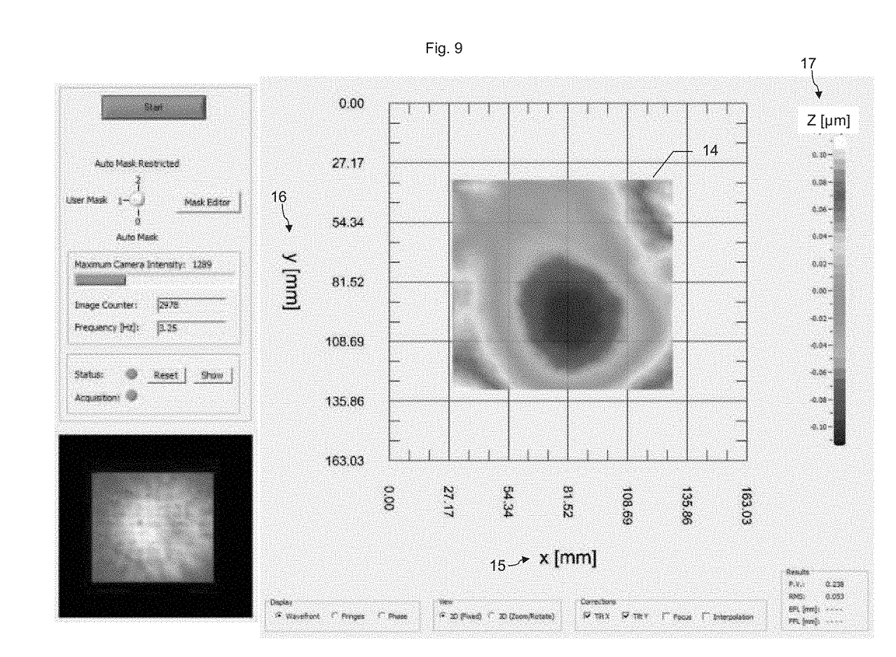

FIG. 9 shows a density plot of a measurement within an area of 101×96 millimeters of yet another distorted wavefront 14 transmitted through an optical band pass filter according to the invention. The measurement, which belongs to the same experiment as in FIG. 8, is based on a larger analysis area than in FIG. 8. The TWD (RMS=0.053 micrometers) is below λ/10 (λ/10=0.063 micrometers with)=633 nanometers being the reference wavelength). The P.V. difference (0.238 micrometers) is below 0.3 micrometers, which may be a preferred quality standard.

What is claimed is:

1. A method for manufacturing an optical filter, comprising:
providing a plurality of optical elements each comprising a substrate with two opposing major surfaces;
providing a spacer or a surface-covering adhesive layer for holding at least two of said plurality of optical elements at a predefined distance;
assembling said plurality of optical elements such that said plurality of optical elements are arranged adjacent to each other to define said optical filter, said plurality of optical elements having at least two adjacent optical elements that are held at a predefined distance and with a cavity in between by said spacer or surface covering adhesive layer;
determining an examination property regarding optical properties of said optical filter as a whole or at least one of said plurality of optical elements; and
using said examination property for said step of assembling said plurality of optical elements and/or for performing a refinement step on at least one of said plurality of optical elements.

2. The method according to claim 1, wherein said step of assembling comprises assembling so that said optical filter has an aperture area of at least 1225 square millimeters.

3. The method according to claim 1, further comprising coating at least one of said two opposing major surfaces with a layer of coating material.

4. The method according to claim 3, wherein said coating step comprises:
using a deposition mask during sputter deposition for influencing a spatial distribution and/or thickness of said layer of coating material; and/or
using a magnetic field during sputter deposition for influencing said spatial distribution and/or thickness of said layer of coating material.

5. The method according to claim 1, wherein said determining step comprises determining a transmitted wavefront distortion as said examination property, and wherein said transmitted wavefront distortion is determined for at least one test wavelength of an optical system being either said optical filter as a whole or said at least one of said plurality of optical elements.

6. The method according to claim 5, wherein said transmitted wavefront distortion is defined as a standard deviation of a difference variable for at least 1000 points being regularly distributed over a calculation area of transmitted wavefronts of a plane wave of said test wavelength being transmitted through said optical system in direction of an optical axis of said optical system, wherein said difference variable specifies a distance in a direction of said optical axis between said transmitted wavefronts and a plane which is perpendicular to said optical axis and located at a mean value of said at least 1000 points, and wherein said calculation area of transmitted wavefronts is a projection of a planar area along said optical axis onto said wavefronts.

7. The method according to claim 1, wherein said determining step comprises determining a variation of a characteristic wavelength as said examination property, and wherein said variation of a characteristic wavelength is determined over an aperture area of an optical system being either said optical filter as a whole or said at least one of said plurality of optical elements.

8. The method according to claim 7, wherein said characteristic wavelength is a transition wavelength between a light-transmitting spectral range and a light-blocking spectral range or a central wavelength of one of said light-transmitting spectral range and said light-blocking spectral range.

9. The method according to claim 8, wherein said transition wavelength is defined as a wavelength between said light-transmitting spectral range and said light-blocking spectral range at which a transmittance of said optical system is |T̅_̅{̅L̅T̅}̅+T̅_̅{̅L̅B̅}̅|/2, wherein T̅_̅{̅L̅T̅}̅ is said average transmittance within said light-transmitting spectral range and T̅_̅{̅L̅B̅}̅ is said average transmittance within said light-blocking spectral range.

10. The method according to claim 1, wherein said determining step comprises determining an edge steepness as said examination property, and wherein said edge steepness is determined of an optical system being either said optical filter as a whole or said at least one of said plurality of optical elements.

11. The method according to claim 10, wherein said edge steepness is defined as |λ_{LT}−λ_{LB}|/λ_{LB}, wherein λ_{LT} is a boundary wavelength of a light-transmitting spectral range facing a light-blocking spectral range and λ_{LB} is a boundary wavelength of said light-blocking spectral range facing said light-transmitting spectral range.

12. The method according to claim 1, wherein said determining step comprises determining a transmittance and/or reflectance spectrum as said examination property, and wherein said transmittance and/or reflectance spectrum is determined of an optical system being either said optical filter as a whole or said at least one of said plurality of optical elements.

13. The method according to claim 3, wherein said determining step comprises determining a spatial variation of a layer thickness as said examination property, and wherein said spatial variation of a layer thickness is determined of said layer of coating material.

14. The method according to claim 1, wherein said examination property comprises a first examination property and a second examination property and said plurality of optical elements comprises a first optical element and a second optical element,
wherein said determining step comprises:
determining said first examination property of said first optical element,
determining said second examination property of said second optical element, and
calculating a relative examination property based on said first examination property and said second examination property, and
wherein said using step comprises using said relative examination property for assembling said first and second optical elements with an optimized geometric relationship between said first and second optical elements.

15. The method according to claim 1, further comprising:
comparing said examination property with a specified quality standard; and
deciding whether said determined examination property satisfies said specified quality standard, and if said comparing step decides that said examination property does not satisfy said specified quality standard,
wherein said using step comprises performing a refinement step on at least one of said plurality of optical elements.

16. The method according to claim 1, wherein said using step comprises performing said refinement step, and wherein said refinement step comprises a step selected from the group consisting of polishing said at least one optical element, adjusting a deposition mask, adjusting a magnetic field, re-coating at least one of said two opposing major surfaces using sputter deposition, adjusting a facing orientation of said at least one optical element, adjusting a rotational angle of said at least one optical element around an optical axis, adjusting a position of said at least one optical element on the optical axis, and any combinations thereof.

17. An optical filter comprising:
at least one optical element comprising a substrate with two opposing major surfaces, said optical filter is either a short-pass filter, a long-pass filter or a band-pass filter with at least one light-transmitting spectral range and at least one light-blocking spectral range, and said optical filter having one or more of the following features:
an aperture area of at least 1225 square millimeters,
a transmitted wavefront distortion (TWD) for at least one test wavelength is less than half of said at least one test wavelength, and
a variation of a characteristic wavelength over an aperture area that is less than ±0.25 percent.

18. The optical filter according to claim 17, further comprising a transmittance that transitions between said at least one light-transmitting spectral range and said at least one light-blocking spectral range with an edge steepness of less than 2 percent.

19. The optical filter according to claim 17, wherein at least one of said two opposing major surfaces is coated with at least one optical layer.

20. The optical filter according to claim 17, wherein said substrate is selected from the group consisting of an optical glass, a technical glass, a filter glass, an infrared material, and a crystal.

21. The optical filter according to claim 17, wherein at least one of said two opposing major surfaces has a shape selected from the group consisting of flat, convex, and concave.
